(19) United States
(12) Patent Application Publication
(10) Pub. No.: US 2025/0306791 A1
(43) Pub. Date: Oct. 2, 2025

(54) ONLINE MIGRATION OF A STORAGE APPLIANCE FROM ONE DISK TYPE TO ANOTHER

(71) Applicant: NetApp, Inc., San Jose, CA (US)

(72) Inventors: Mrinal K. Bhattacharjee, Bangalore (IN); Sateesh Kumar Pola, Bangalore (IN); Shivali Gupta, Bangalore (IN)

(73) Assignee: NetApp, Inc., San Jose, CA (US)

(21) Appl. No.: 18/617,356

(22) Filed: Mar. 26, 2024

(51) Int. Cl. G06F 3/06

(52) U.S. Cl. CPC G06F 3/0647; G06F 3/0613; G06F 3/067

(57) ABSTRACT

Systems and methods for performing an online migration of a storage solution deployment from one disk type to another are provided. In various examples described herein, after a storage solution has been deployed that utilizes disks of a first disk type (e.g., a Google Cloud Platform (GCP) Persistent Disk (PD)), the storage solution deployment may be modified to make use of a second disk type (e.g., a GCP Hyperdisk (HD)) without incurring downtime. In one embodiment, the online migration involves adding new disks of the second disk type to an aggregate of which the original disks of the first disk type are a part, mirroring writes to both the original disks and the new disks, and copying valid data from a given original disk to a corresponding new disk during a background scan of each of the set of original disks.

### BACKGROUND

### Field

Various embodiments of the present disclosure generally relate to data storage appliances. In particular, some embodiments relate to an approach for performing an online or “live” migration of a deployment of a storage solution (e.g., a physical or virtual storage appliance) that makes use of an existing (or original) set of one or more disks of a particular disk type to a new set of one or more disk of a different disk type.

### Description of the Related Art

New disk types are continuously being introduced for use in on-prem storage solutions (e.g., physical storage appliances) and cloud-based storage solutions (e.g., virtual storage appliances). The difference between one disk type and another may relate their respective properties/characteristics (e.g., storage volume, speed, efficiency, cost per unit of storage, cost per Input/Output Operations per Second (IOPS), and/or the like). The difference between one disk type and another may additionally or alternatively relate to the storage technology used. For example, hard disk drives (HDDs) are mechanical in nature and include one or more magnetically sensitive platters, an actuator arm with a read/write head on it for each platter, and a motor to spin the platters and move the arms, whereas solid-state drives (SSDs) are semiconductor-based storage devices with no moving parts and use flash memory that uses silicon's physical and chemical properties to store data. Furthermore, the difference between one disk type and another may alternatively or additionally relate to a particular “flavor” of a given disk technology. For example, there are multiple types of HDDs, including, but not limited to Parallel Advanced Technology Attachment (PATA) HDDs, Serial Advanced Technology Attachment (SATA) HDDs, Small Computer System Interface (SCSI) HDDs, and Non-volatile Memory Express (NVMe) HDDs. Similarly, there are multiple types of SSDs, including multi-level cell (MLC) SSDs, Quad-level cell (QLC) SSD, and triple-level cell (TLC) SSDs.

Storage solutions generally provide a pool of storage made up of a set of one or more disks for use by one or more clients (e.g., applications) and may be deployed with a given type of disks. After deployment, for example, due to the availability of improved technology, it may be desirable to modify (e.g., upgrade) the storage solution deployment to make use of a different disk type.

### SUMMARY

Systems and methods are described for performing an online migration of a storage solution deployment from one disk type to another. According to one embodiment, after determining an online migration is to be performed from an original disk of a first disk type within an aggregate of a storage appliance to a new disk of a second disk type, the new disk is added to the aggregate. Writes received by the storage appliance during the online migration are caused to be sent to both the original disk and the new disk by establishing a mirror relationship between the original disk and the new disk. Reads received by the storage appliance during the online migration continue to be served from the original disk. During performance of a scan of the original disk, valid data is copied from the original disk to the new disk. After the scan is complete, the mirror relationship is broken and the original disk is removed from the aggregate.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a high-level block diagram conceptually illustrating a virtual storage system with hyperscale disks in accordance with an embodiment of the present disclosure.

FIG. 2A is a block diagrams conceptually illustrating an initial state of an aggregate including a set of disks of a first disk type in accordance with an embodiment of the present disclosure.

FIG. 2B is a block diagrams conceptually illustrating an intermediate state of the aggregate after online migration has been initiated in which a set of disks of a second disk type have been added and mirroring relationships have been established to mirror writes in accordance with an embodiment of the present disclosure.

FIG. 2C is block diagram conceptually illustrating a final state of the aggregate after the online migration has been completed to the set of disks of the second disk type in accordance with an embodiment of the present disclosure.

FIG. 3 is a block diagram illustrating an example of file system components that may be involved in the performance of online migration in accordance with an embodiment of the present disclosure.

FIG. 4 is a flow diagram illustrating a set of operations for performing online migration in accordance with an embodiment of the present disclosure.

FIG. 5 illustrates an example computer system in which or with which embodiments of the present disclosure may be utilized.

### DETAILED DESCRIPTION

Systems and methods are described for performing an online migration of a storage solution deployment from one disk type to another. As noted above, after a storage solution has been deployed that utilizes a set of one or more disks of a given type, it may be desirable to subsequently modify the storage solution deployment to make use of a different disk type. For example, using the Google Cloud Platform (GCP) as a non-limiting example of a cloud in which a virtual storage appliance may be operating, the virtual storage appliance may be initially deployed with a set of one or more GCP Persistent Disk (PDs) volumes (representing premium SSD disks in which IOPS generally scale with capacity). For various reasons, for example, the flexibility of accommodating both thin provisioning and paying for a desired level of IOPS independent of capacity, the storage solution vendor and/or the customer may wish to upgrade the storage solution deployment to make use of a set of one or more disks of a newly introduced disk type (e.g., GCP Hyperdisk (HD)). At present, such a migration generally requires downtime, the amount of which varies based on the volume of data stored on the set of one or more disks of the storage solution at issue. Assuming terabytes (TBs) or petabytes (PBs) of data need to be moved/copied from the set of one or more disks of a first type (e.g., PD) to a set of one or more disks of a second type (e.g., HD), such a migration might involve downtime of a number of days.

Embodiments described herein seek to avoid the downtime associated with migrating a storage solution from one disk type to another by performing an online (or “live” migration). According to one embodiment and as described further below, reads and writes may continue to be served by a storage appliance while a background scan is performed of a set of one or more original disks of a first disk type. During the background scan, valid data stored on each of the original disks is copied to a corresponding new disk of a set of one or more new disks of a second disk type.

While in the context of various examples, online migration of a storage solution (e.g., a virtual storage appliance) from one disk type offered by a cloud provider to another disk type offered by the cloud provider are described, it is to be appreciated the online migration approaches described herein are also applicable to on-prem storage solutions (e.g., physical storage appliances), for example, migrating a storage solution from a set of one or more HDDs to a set of one or more SSD, from a set of one or more SSDs or HDDs of a first technology to a set of one or more SSDs or HDDs of a second technology, and the like.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein a “cloud,” “cloud platform,” “cloud environment,” or the like broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider or hyperscaler (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability and mobility (e.g., cloud bursting for load balancing between clouds).

As used herein, a “storage appliance” generally refers to a type of computing appliance, in virtual or physical form, that provides data to or manages data for or on behalf of other computing devices or clients (e.g., applications).

As used herein, a “storage aggregate” or simply an “aggregate” generally refers to a collection of disks (or partitions) that may be arranged into one or more redundant array of independent disk (RAID) groups. An aggregate may be composed of drives or array LUNs that may be associated with a given node of a cluster of nodes of a distributed storage system or that may represent a storage POD shared by (or accessible to) all of the nodes of the cluster.

As used herein, a “hyperscale disk” generally refers to a storage volume or cloud volume supplied by a hyperscaler or cloud provider. Non-limiting examples of hyperscale disks include Amazon Web Services (AWS) Elastic Block Store (EBS), GCP PDs, and Microsoft Azure managed disks (MDs). Such cloud volumes may represent persistent storage that is accessible to a virtual storage system by virtue of the persistent storage being associated with a compute instance in which the virtual storage system is running. A cloud volume may represent an HDD or an SSD from a pool of storage devices within a cloud environment that is connected to the compute instance through Ethernet or fibre channel (FC) switches as is the case for network-attached storage (NAS) or a storage area network (SAN). Non-limiting examples of cloud volumes include various types of SSD volumes (e.g., GCP PD volumes, GCP HD volumes, AWS EBS gp2, gp3, io1, and io2 volumes for EC2 instances) and various types of HDD volumes (e.g., AWS EBS st1 and sc1 volumes for EC2 instances).

### Example Operating Environment

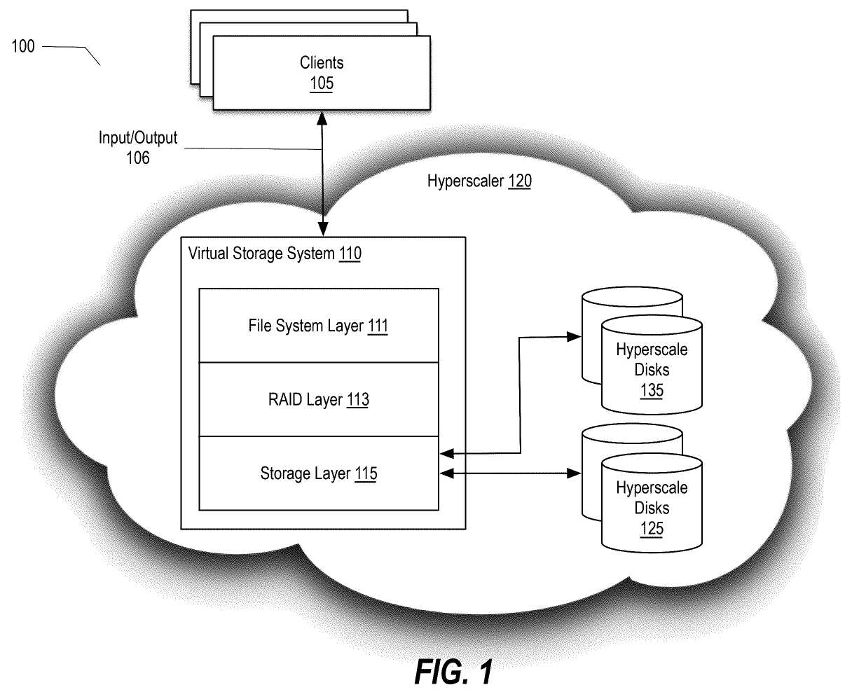

FIG. 1 is a block diagram illustrating an environment 100 in which various embodiments may be implemented. In various examples described herein, a storage appliance (e.g., virtual storage system 110) may be run (e.g., on a VM or as a containerized instance, as the case may be) within a public cloud provider (e.g., hyperscaler 120). In the context of the present example, the virtual storage system 110 makes use of cloud volumes/disks (e.g., a set of one or more hyperscale disks 125 of a first disk type or a set of one or more hyperscale disks 135 of a second disk type) provided by the hyperscaler 120. Hyperscaler 120 may provide various types of cloud volumes/disks having different performance characteristics, sizes, and pricing. Non-limiting examples of cloud volumes/disks include AWS EBS, GCP PDs, GCP HDs, and Microsoft Azure MDs.

The virtual storage system 110 may present storage over a network to clients 105 using various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients 105 may request services of the virtual storage system 110 by issuing Input/Output requests 106 (e.g., file system protocol messages (in the form of packets) over the network). A representative client of clients 105 may comprise an application, such as a database application, executing on a computer that “connects” to the virtual storage system 110 over a computer network, such as a point-to-point link, a shared local area network (LAN), a wide area network (WAN), or a virtual private network (VPN) implemented over a public network, such as the Internet.

In the context of the present example, the virtual storage system 110 is shown including a number of layers, including a file system layer 111, a RAID layer 113, and a storage layer 115. These layers may represent components of data management software (e.g., ONTAP data management software from NetApp, Inc. of San Jose, CA) (not shown) of the virtual storage system 110. The file system layer 111 generally defines the basic interfaces and data structures in support of file system operations (e.g., initialization, mounting, unmounting, creating files, creating directories, opening files, writing to files, and reading from files). The RAID layer 113 encapsulates data storage virtualization technology for combining multiple disks into RAID groups, for example, for purposes of data redundancy, performance improvement, or both. The storage layer 115 may include storage drivers for interacting with the various types of hyperscale disks supported by the hyperscaler 120.

### Example of Online Migration

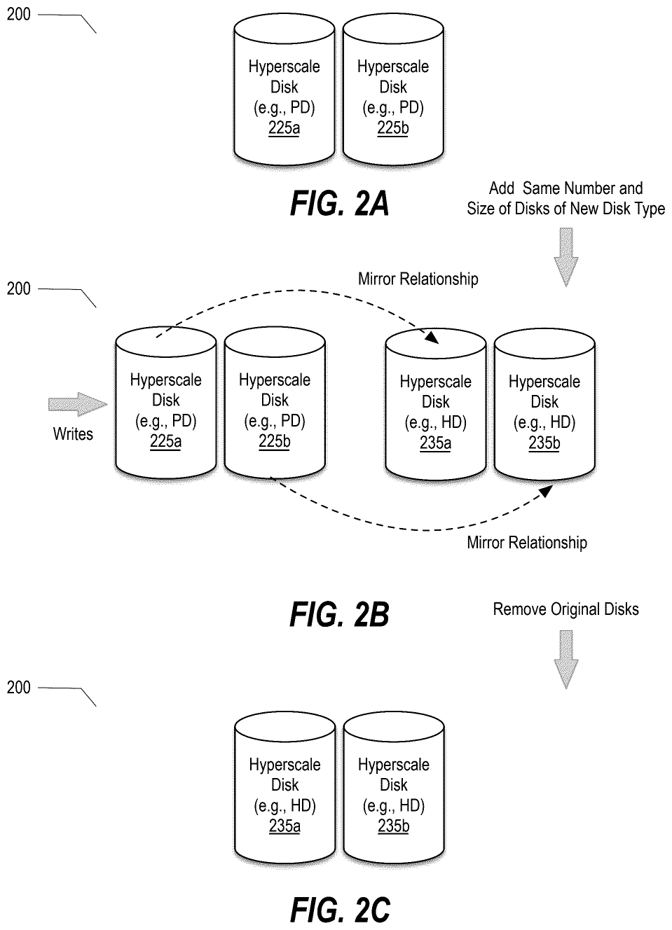

FIG. 2A is a block diagram conceptually illustrating an initial state of an aggregate 200 including a set of original disks (a set of disks of a first disk type) in accordance with an embodiment of the present disclosure. In the context of the present example, the set of disks of the first disk type includes two hyperscale disks 225a-b (e.g., GCP PD volumes).

In one embodiment, the aggregate 200 may represent a file system aggregate of a file system (e.g., a Copy-on-Write file system, such as the proprietary Write Anywhere File Layout (WAFL) file system (available from NetApp, Inc. of San Jose, CA)). The file system (e.g., file system layer 111), may represent a component or layer of data management software (e.g., ONTAP data management software) running on a storage appliance (e.g., virtual storage system 110). Depending upon the virtual or physical nature of the storage appliance, the set of disks of the first type may be analogous to hyperscale disks 125 of FIG. 1 or disks associated with a disk or storage array (e.g., a fabric attached storage (FAS) storage array), respectively.

After a trigger event indicates an online migration is to be performed from the set of disks of the first disk type to a new set of disks (a set of disks of a second disk type), the same number and size of disks of the second disk type (e.g., GCP HD volumes) may be added to the aggregate as shown in FIG. 2B. Depending on the nature of the storage solution (e.g., virtual storage system 110) at issue (e.g., a managed storage service), the trigger event may represent detection of availability of the second disk type within a cloud in which the storage solution is deployed. Alternatively or additionally, the trigger event may represent receipt of a request from an administrative user of the storage solution.

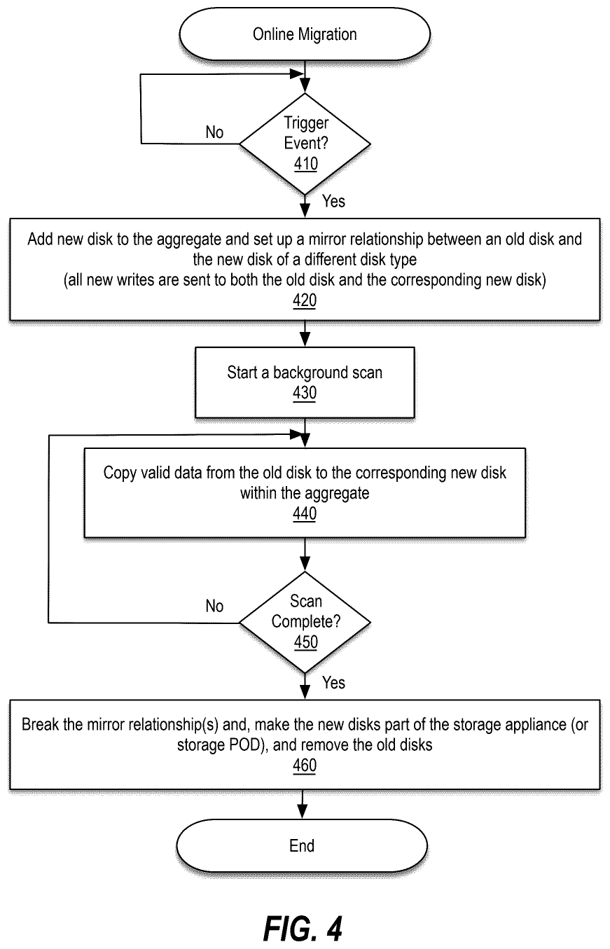

FIG. 2B is a block diagram conceptually illustrating an intermediate state of the aggregate 200 after online migration has been initiated in which the new set of disks (the set of disks of the second disk type) have been added and mirroring relationships have been established to mirror writes in accordance with an embodiment of the present disclosure. In the context of the present example, the set of disks of the second disk type includes two hyperscale disks 235a-b (e.g., GCP HD volumes). As above, depending upon the virtual or physical nature of the storage appliance, the set of disks of the second type may be analogous to hyperscale disks 135 of FIG. 1 or disks associated with a disk or storage array (e.g., a FAS storage array), respectively. As described further below with reference to FIG. 4, after the set of disks of the second disk type has been added to the aggregate, a mirroring relationship may be established between each disk of the set of disks of the first type and a respective disk of the set of disks of the second type to cause all new writes performed to a disk of the set of disks of the first type after establishment of the mirroring relationships to be mirrored to the set of disks of the second type. During the online migration process, reads may continue to be serviced from the original set of disks (the set of disks of the first type). Additionally, while not shown, a scan may be started for each disk of the set of disks of the first disk type to copy the data to the corresponding disk of the set of disks of the second disk type. The scan may run in the background and copy all valid data blocks from the start of the disk (e.g., the beginning physical volume block number (PVBN) of the disk) to the end of the disk (e.g., the ending PVBN of the disk) to the corresponding disk of the second disk type. In one embodiment, to the extent mirrored writes are performed ahead of the scanning process, an optimization may be implemented as part of the scanning process to avoid (re)copying a data block that has been written to the corresponding disk of the second disk type as a result of the mirroring relationship. In another embodiment, no further optimization is performed in the block copy.

FIG. 2C is block diagram conceptually illustrating a final state of the aggregate 200 after the online migration has been completed from the original set of disks (the set of disks of the first disk type) to the new set of disks (the set of disks of the second disk type) in accordance with an embodiment of the present disclosure. As described further below with reference to FIG. 4, once the scan has been completed for all original disks, subsequent storage requests (e.g., client reads and/or writes) may be directed to the new disks (e.g., the set of disk of the second disk type), the previously established mirroring relationships may be disbanded or broken, and the original disks may be removed.

In this manner, the migration of all valid data previously stored on the original disks is copied (while the storage system remains online or live) to the new disks without disrupting ongoing access to the data and downtime is avoided.

### Example File System Components

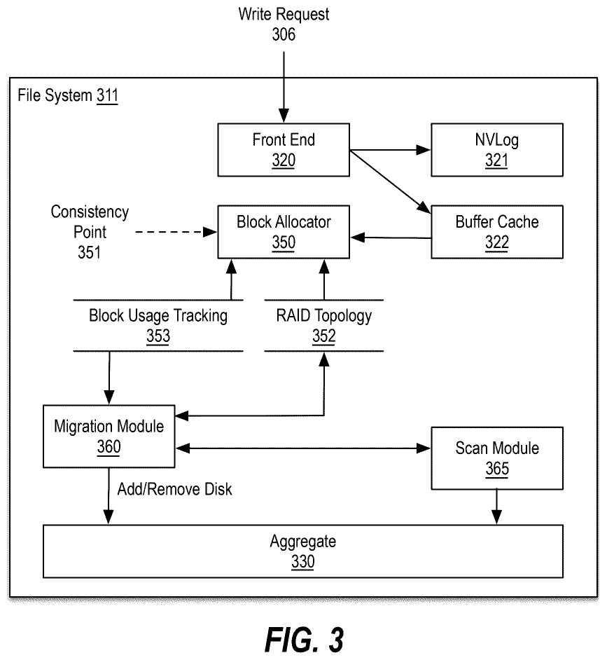

FIG. 3 is a block diagram illustrating an example of file system components that may be involved in performing online migration in accordance with an embodiment of the present disclosure. In the context of the present example, a file system 311 (which may be analogous to file system layer 111 is shown including a front end 320, a non-volatile log (NVlog) 321 (e.g., in NV random access memory (NVRAM)), a buffer cache 322 (e.g., in RAM), a block allocator 350, a block usage tracking data store 353, a RAID topology data store 352, a migration module 360, a scan module 365, and the aggregate 330 (which may be analogous to an aggregate of a given node of a cluster of nodes representing a distributed storage system or multiple 230).

The file system 511 may be a write-anywhere file system that does not overwrite data on disks. Instead, a data block is retrieved from a disk into a memory may be updated or modified (i.e., dirtied) with new data, the data block is thereafter written to a new location on the disk. When accessing a block of a file in response to a request, the files system specifies a volume block number (VBN) that is translated to a disk block number (DBN) location on a particular disk within a RAID group. Since each block in the VBN space and in the DBN space is typically fixed (e.g., 4K bytes) in size, there is typically a one-to-one mapping between the information stored on disks in the DBN space and the information organized by the file system in the VBN space.

The block usage tracking data store 553 may include information regarding blocks within a VBN space that are used and unused. For example, for each VBN of the aggregate 330, the block usage tracking data store 353 may include a flag indicative of whether the corresponding DBN contains valid data.

The RAID topology data store 352 may include a data structure for each file system disk and corresponding backing disk including information indicative of, among other things, a base VBN, a range of DBNs (e.g., the minimum usable DBN and the maximum usable DBN.

The front end 320 may be responsible for, among other things, receiving write requests (e.g., write request 306), persisting information (e.g., the VBN and the data to be written to the VBN) regarding a given write request in the NVlog 321 and the buffer cache 322, and marking updated buffers in the buffer cache 322 as dirty to facilitate periodic flushing to disk. Such an approach allows the front end 320 to promptly send an acknowledgement to the client (e.g., one of clients 105 of FIG. 1) that originated the write request 306 without waiting for the data to be persisted to a disk within the aggregate 330. The delayed sending of dirty data to the disk also provides other benefits, such as amortized overhead of allocation and improved on-disk layout by grouping related data blocks together. In a write-anywhere file system, the point in time when a collection of changes to the data blocks is sent to the disk is known as a consistency point (e.g., consistency point 351). A consistency point (CP) may conceptually be considered a point-in-time image of the updates to the file system since the previous CP. The process of emptying the buffer cache 322 by sending the dirty data to the disk may be accomplished by collecting a list of index nodes (inodes) that have been modified since the last CP and then cleaning the inodes, for example, by having the block allocator 350 assign new locations on disk for the dirty buffers and then flushing the buffers to those locations on disk.

The block allocator 350 may be responsible for assigning the new locations on disk for the dirty buffers based on information stored in the block usage tracking data store 353 and the RAID topology data store 352.

The migration module 360 may be responsible for monitoring storage utilization of the aggregate 330 and adding/removing disks to the aggregate 330 as part of the online migration process (e.g., copying data from a set of one or more original disks of a first disk type to a set of one or more new disks of a second disk type). The migration module 360 or the scan module (e.g., at the direction of the migration module 360) will perform relocation of valid data during a scan (e.g., a background scan) from the beginning to the end of a given original disk to a corresponding new disk (added to the aggregate 330 as part of the online migration process). In one embodiment, reads and writes may continue to be processed concurrently with the relocation (migration) of data from the set of one or more original disks to respective disks of the set of one or more new disks of a different type. In this manner, the migration from the set of one or more original disks of a first type (e.g., PD volume) to the set of one or more new disks of a second type (e.g., HD volume) may be performed while the storage appliance is online (live) and continues serving reads and writes received from its clients (i.e., without taking any downtime).

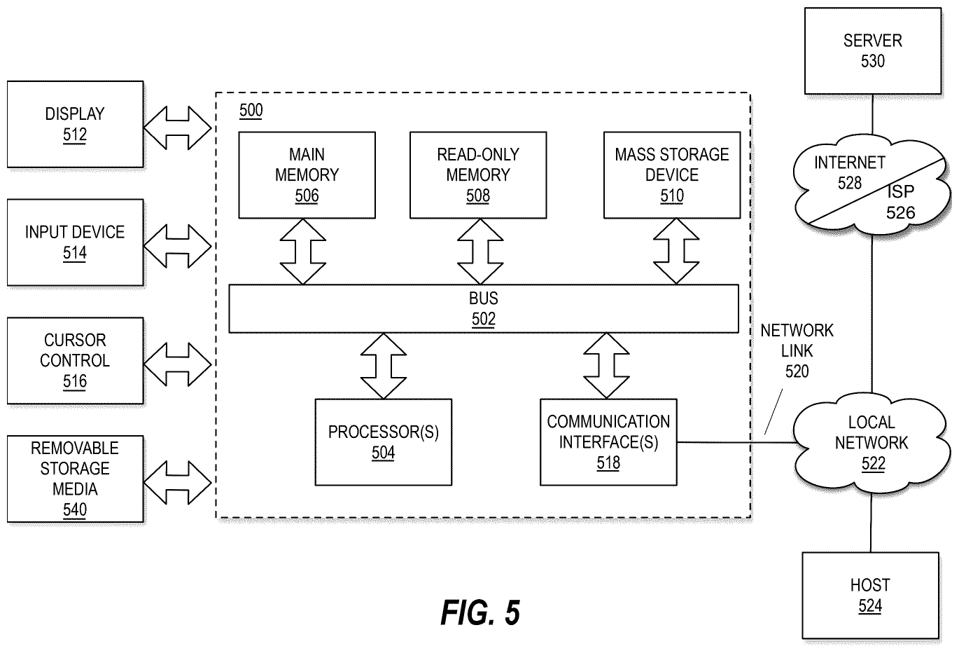

The various layers and components/modules described herein, and the processing described below with reference to the flow diagram of FIG. 4 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms, such as the computer system described with reference to FIG. 5 below.

### Example Online Migration

FIG. 4 is a flow diagram illustrating a set of operations for performing online migration in accordance with an embodiment of the present disclosure. In one embodiment, the processing described with reference to FIG. 4 may be performed by a storage appliance (e.g., virtual storage system 110) in response to a trigger event. Depending upon the particular implementation, this processing may be performed by a process associated with the file system (e.g., file system layer 111) or by an external process.

At decision block 410, it is determined by a file system (e.g., file system layer 111 or file system 311) of the storage appliance whether a trigger event has occurred that indicates an online migration is to be initiated from an original set of disks (e.g., hyperscale disks 225a-b) of a first disk type (e.g., GCP PD volumes) to a new set of disks (e.g., hyperscale disks 235a-b) of a second disk type (e.g. GCP HD volumes). If so, processing continues with block 420. As noted above, in the context of a managed storage service, the trigger event may represent detection of availability of the second disk type within a cloud in which the storage appliance is deployed. Alternatively or additionally, the trigger event may represent receipt of a request from an administrative user of the storage appliance.

At block 420, one or more new disks of the second disk type are added to an aggregate (e.g., file system aggregate 330) of which the original set of disks are a part. As noted above, with reference to FIG. 2A, in one embodiment, the number and size of the new disks added to the aggregate are the same as the number and size of the original set of disks. Additionally, mirror relationships are set up between each original disk and a corresponding new disk. This mirror relationship causes all new writes to the original disks to also be sent to the corresponding new disks. In this manner, even data associated with writes that are performed behind the scanning process that is started in block 430 will be migrated to the new disks.

At block 430, a scan is started. For example, a migration module (e.g., migration module 360) may cause a scan module (e.g., scan module 365) to initiate performance of a background scan, for example, from the beginning PVBN of each original disk to the ending PVBN of each original disk.

At block 440, during the scan the scan module copies valid data from each of the original disks in the original set of disks to a corresponding new disk in the new set of disks.

At decision block 450, it is determined if the scan is complete. If so, processing continues with block 460; otherwise, processing loops back to block 440. In one embodiment, the scan is complete when it has reached the last PVBN of the last of the original disks.

At block 460, the mirror relationships among corresponding original disks and new disks are broken and the new disks are made part of the storage appliance or the storage POD as the case may be and the old disks are removed from the aggregate.

While in the context of the example described with reference to the flow diagram of FIG. 4 a number of enumerated blocks are included, it is to be understood that examples may include additional blocks before, after, and/or in between the enumerated blocks. Similarly, in some examples, one or more of the enumerated blocks may be omitted and/or performed in a different order.

### Example Computer System

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 5 is a block diagram that illustrates a computer system 500 in which or with which an embodiment of the present disclosure may be implemented. Computer system 500 may be representative of all or a portion of the computing resources associated with a storage appliance (e.g., virtual storage system 110). Notably, components of computer system 500 described herein are meant only to exemplify various possibilities. In no way should example computer system 500 limit the scope of the present disclosure. In the context of the present example, computer system 500 includes a bus 502 or other communication mechanism for communicating information, and one or more processing resources (e.g., one or more hardware processors 504) coupled with bus 502 for processing information. Hardware processor(s) 504 may include, for example, one or more general purpose microprocessors.

Computer system 500 also includes a main memory 506, such as a random access memory (RAM) or other dynamic storage device, coupled to bus 502 for storing information and instructions to be executed by processor(s) 504. Main memory 506 also may be used for storing temporary variables or other intermediate information during execution of instructions to be executed by processor(s) 504. Such instructions, when stored in non-transitory storage media accessible to processor(s) 504, render computer system 500 into a special-purpose machine that is customized to perform the operations specified in the instructions.

Computer system 500 further includes a read only memory (ROM) 508 or other static storage device coupled to bus 502 for storing static information and instructions for processor(s) 504. A storage device 510, e.g., a magnetic disk, optical disk or flash disk (made of flash memory chips), is provided and coupled to bus 502 for storing information and instructions.

Computer system 500 may be coupled via bus 502 to a display 512, e.g., a cathode ray tube (CRT), Liquid Crystal Display (LCD), Organic Light-Emitting Diode Display (OLED), Digital Light Processing Display (DLP) or the like, for displaying information to a computer user. An input device 514, including alphanumeric and other keys, is coupled to bus 502 for communicating information and command selections to processor(s) 504. Another type of user input device is cursor control 516, such as a mouse, a trackball, a trackpad, or cursor direction keys for communicating direction information and command selections to processor(s) 504 and for controlling cursor movement on display 512. This input device typically has two degrees of freedom in two axes, a first axis (e.g., x) and a second axis (e.g., y), that allows the device to specify positions in a plane.

Removable storage media 540 can be any kind of external storage media, including, but not limited to, hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM), USB flash drives and the like.

Computer system 500 may implement the techniques described herein using customized hard-wired logic, one or more ASICs or FPGAs, firmware or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 510. Volatile media includes dynamic memory, such as main memory 506. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor(s) 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor(s) 504 retrieve and execute the instructions. The instructions received by main memory 506 may optionally be stored on storage device 510 either before or after execution by processor(s) 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor(s) 504 as it is received, or stored in storage device 510, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
after determining an online migration is to be performed from an original disk of a first disk type within an aggregate of a storage appliance to a new disk of a second disk type, adding the new disk to the aggregate;
causing writes received by the storage appliance during the online migration to be sent to both the original disk and the new disk by establishing a mirror relationship between the original disk and the new disk;
serving reads received by the storage appliance during the online migration from the original disk;
during performance of a scan of the original disk, copying valid data from the original disk to the new disk; and
after the scan is complete, breaking the mirror relationship and removing the original disk from the aggregate.

2. The method of claim 1, wherein the scan comprises a background scan.

3. The method of claim 1, wherein the online migration is performed from a plurality of original disks of the first type, including the original disk, to a corresponding plurality of new disks of the second type, including the new disk.

4. The method of claim 3, wherein a number of the corresponding plurality of new disks added to the aggregate and a size a given new disk of the corresponding plurality of new disks is equal to a number of the plurality of original disks and a size of a given original disk of the plurality of original disks, respectively.

5. The method of claim 1, wherein the first disk type and the second disk type differ in relation to one or more of storage volume, speed, efficiency, cost per unit of storage, cost per Input/Output Operations per Second (IOPS), storage technology, and flavor of a given storage technology.

6. The method of claim 1, wherein the storage appliance comprises a virtual storage system, the first disk type comprises a first type of hyperscale disk, and the second disk type comprises a second type of hyperscale disk.

7. A non-transitory machine readable medium storing instructions, which when executed by one or more processing resources of a storage appliance, cause the storage appliance to:
after determining an online migration is to be performed from an original disk of a first disk type within an aggregate of the storage appliance to a new disk of a second disk type, add the new disk to the aggregate;
cause writes received by the storage appliance during the online migration to be sent to both the original disk and the new disk by establishing a mirror relationship between the original disk and the new disk;
serve reads received by the storage appliance during the online migration from the original disk;
during performance of a scan of the original disk, copy valid data from the original disk to the new disk; and
after the scan is complete, break the mirror relationship and remove the original disk from the aggregate.

8. The non-transitory machine readable medium of claim 7, wherein the scan comprises a background scan.

9. The non-transitory machine readable medium of claim 7, wherein the online migration is performed from a plurality of original disks of the first type, including the original disk, to a corresponding plurality of new disks of the second type, including the new disk.

10. The non-transitory machine readable medium of claim 9, wherein a number of the corresponding plurality of new disks added to the aggregate and a size a given new disk of the corresponding plurality of new disks is equal to a number of the plurality of original disks and a size of a given original disk of the plurality of original disks, respectively.

11. The non-transitory machine readable medium of claim 7, wherein the first disk type and the second disk type differ in relation to one or more of storage volume, speed, efficiency, cost per unit of storage, cost per Input/Output Operations per Second (IOPS), storage technology, and flavor of a given storage technology.

12. The non-transitory machine readable medium of claim 7, wherein the storage appliance comprises a virtual storage system and the original disk and the new disk comprise hyperscale disks.

13. The non-transitory machine readable medium of claim 7, wherein the storage appliance comprises a physical storage system and the original disk and the new disk comprise hard disk drives (HDDs) or solid-state drives (SSDs).

14. A storage system comprising:
one or more processing resources; and
instructions that when executed by the one or more processing resources cause the storage system to:
after determining an online migration is to be performed from an original disk of a first disk type within an aggregate of the storage system to a new disk of a second disk type, add the new disk to the aggregate;
cause writes received by the storage appliance during the online migration to be sent to both the original disk and the new disk by establishing a mirror relationship between the original disk and the new disk;
serve reads received by the storage system during the online migration from the original disk;
during performance of a scan of the original disk, copy valid data from the original disk to the new disk; and
after the scan is complete, break the mirror relationship and remove the original disk from the aggregate.

15. The storage system of claim 14, wherein the scan comprises a background scan.

16. The storage system of claim 14, wherein the online migration is performed from a plurality of original disks of the first type, including the original disk, to a corresponding plurality of new disks of the second type, including the new disk.

17. The storage system of claim 16, wherein a number of the corresponding plurality of new disks added to the aggregate and a size a given new disk of the corresponding plurality of new disks is equal to a number of the plurality of original disks and a size of a given original disk of the plurality of original disks, respectively.

18. The storage system of claim 14, wherein the first disk type and the second disk type differ in relation to one or more of storage volume, speed, efficiency, cost per unit of storage, cost per Input/Output Operations per Second (IOPS), storage technology, and flavor of a given storage technology.

19. The storage system of claim 14, wherein the storage system comprises a virtual storage system and the original disk and the new disk comprise hyperscale disks.

20. The storage system of claim 14, wherein the storage system comprises a physical storage system and the original disk and the new disk comprise hard disk drives (HDDs) or solid-state drives (SSDs).
